(19) United States
(12) Patent Application Publication
(10) Pub. No.: US 2004/0047932 A1
(43) Pub. Date: Mar. 11, 2004

(54) Pipe mold apparatus with contact and air cooling of plastic in a mold tunnel

(76) Inventors: Manfred A. A. Lupke, Thornhill (CA); Stefan A. Lupke, Thornhill (CA)

Correspondence Address: Douglas S. Johnson, C/O DENNISON ASSOCIATES, SUITE 301, 133 RICHMOND ST. WEST, TORONTO, ON, M5H 2L7, CA

(21) Appl. No.: 10/236,977

(22) Filed: Sep. 9, 2002

(51) Int. Cl. B29C 47/20

(52) U.S. Cl. 425/72.1; 425/326.1; 425/380

(57) ABSTRACT

A molding apparatus for molding plastic material with a profiled outer pipe wall has a mold tunnel in which plastic material is shaped to form the pipe. The mold tunnel includes a first plastic cooler against which the plastic material flows for contact cooling of the plastic material. The mold tunnel further includes a second plastic cooler downstream of the first plastic cooler. The second plastic cooler provides an air cooling of the plastic material which surrounds the second plastic cooler in the mold tunnel.

### FIELD OF THE INVENTION

The present invention relates to a pipe molding apparatus and means to provide cooling of the plastic material in the mold tunnel of the apparatus.

### BACKGROUND OF THE INVENTION

A known pipe molding apparatus includes what is known in the industry as a moving mold tunnel which shapes molten plastic to form the pipe. The molten plastic must be properly cooled in the mold tunnel to hold the shape of the pipe. This is particularly true in the case of a pipe having a profiled outer surface i.e., ribbed pipe or double wall corrugated pipe.

In the known pipe molding apparatus a plastic cooling device known as a cooling plug is provided internally of the mold tunnel. The molten plastic flowing to the mold tunnel is forced onto the external surface of the cooling plug. This therefore provides cooling to the interior surface of the pipe formed in the mold tunnel.

The purpose of the cooling plug is to set the interior dimension of the pipe at the point where the molten plastic enters the mold tunnel i.e., not only does the mold plug cool the plastic material but it additionally provides a molding surface to define the interior shape of the pipe. Once the plastic material has set up sufficiently to hold its own shape which occurs relatively quickly within the mold tunnel the molding surface provided by the cooling plug is not needed. Therefore the length of the cooling plug is relatively short in comparison to the overall length of the mold tunnel.

In the conventional molding apparatus no further interior cooling of the pipe is provided downstream of the cooling plug within the mold tunnel. However, the plastic material of the pipe although as noted above being sufficiently cooled to hold its own shape still maintains substantial heat energy downstream of the cooling plug.

The known methods of cooling the plastic internally of the pipe in the mold tunnel have very little effect on cooling the outer wall of the pipe particularly if the pipe wall is thickened to provide a profiled outer pipe surface. This would be the case with a ribbed pipe having ribs projecting from the outer wall of the pipe and also with a double wall corrugated pipe.

In order to provide cooling of the outer wall of the pipe in a mold tunnel Corma Inc. of Toronto, Ontario, Canada has developed a cooling system which introduces a cooled gas between the inner surface of the mold tunnel and the outer surface of the pipe. This cooling system helps to cool the exterior surface of the pipe. However, even with the Corma innovation it is difficult to provide a cooling of the pipes outer wall sufficient to hold the shape of the pipe over the full length of the mold tunnel or even after the pipe leaves the mold tunnel. This difficultly arises as a result of the outer wall being re-heated by the heat remaining to the interior surface of the pipe as earlier described.

### SUMMARY OF THE PRESENT INVENTION

The present invention relates to a molding apparatus for molding plastic pipe with a profiled outer pipe wall with additional interior pipe cooling not found in the prior art. This additional material cooling of the pipe helps to hold the shape of the pipe during both travel of the pipe through the mold tunnel and after the pipe leaves the mold tunnel.

More particularly, the molding apparatus of the present invention includes a mold tunnel in which plastic material is shaped to form the pipe with its profiled outer pipe wall. The mold tunnel includes a first plastic cooler against which the plastic material flows for contact cooling of the plastic material. It further includes a second plastic cooler downstream of the first plastic cooler. The second plastic cooler provides an air cooling of the plastic material which surrounds the second plastic cooler in the mold tunnel.

According to a preferred aspect of the present invention the second plastic cooler is of lesser diameter than the first plastic cooler such that it is out of contact with the plastic material. The second plastic cooler then provides cooling air either through a radiant cooling or by positive air pressure from the second plastic cooler onto the interior surface of the plastic pipe.

### BRIEF DESCRIPTION OF THE DRAWINGS

The above as well as other advantages and features of the present invention will be described in greater detail according to the preferred embodiments of the present invention in which;

FIG. 1 is a schematic view of a pipe molding apparatus according to a preferred embodiment of the present invention;

FIG. 2 is an enlarged sectional view through the upstream region of the mold tunnel including first and second plastic coolers according to a preferred embodiment of the present invention; and

FIGS. 3 through 6 show different arrangements of first and second plastic material mold tunnel coolers according to different preferred embodiments of the present invention.

### DETAILED DESCRIPTION ACCORDING TO THE PREFERRED EMBODIMENTS OF THE PRESENT INVENTION IN WHICH

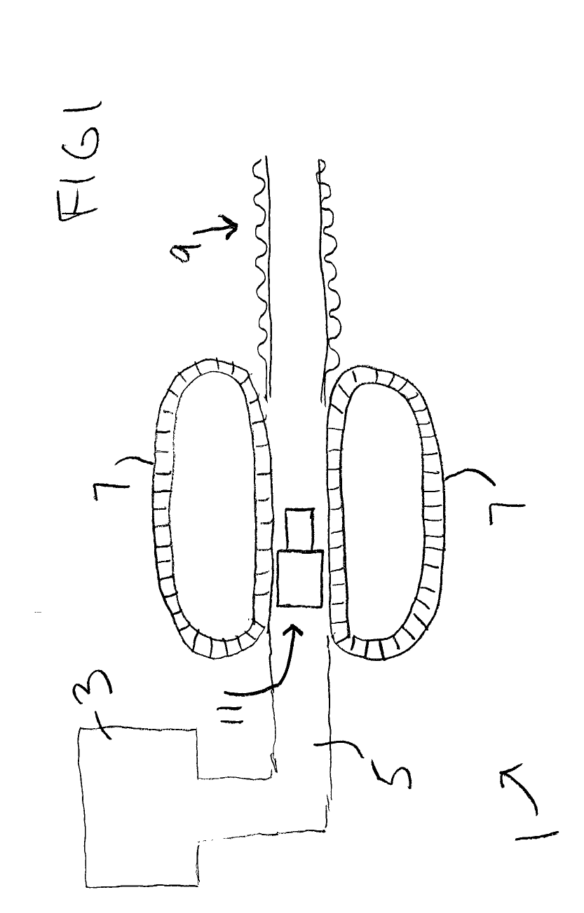

FIG. 1 shows a pipe molding apparatus generally indicated at 1. This apparatus includes a plastic extruder 3 which delivers molten plastic through a die 5 to a corrugator 7. The corrugator forms a plastic pipe 9 having a profiled exterior surface.

Provided interiorly of the apparatus between the two endless belts forming the corrugator 7 is an internal pipe cooling system generally indicated at 11.

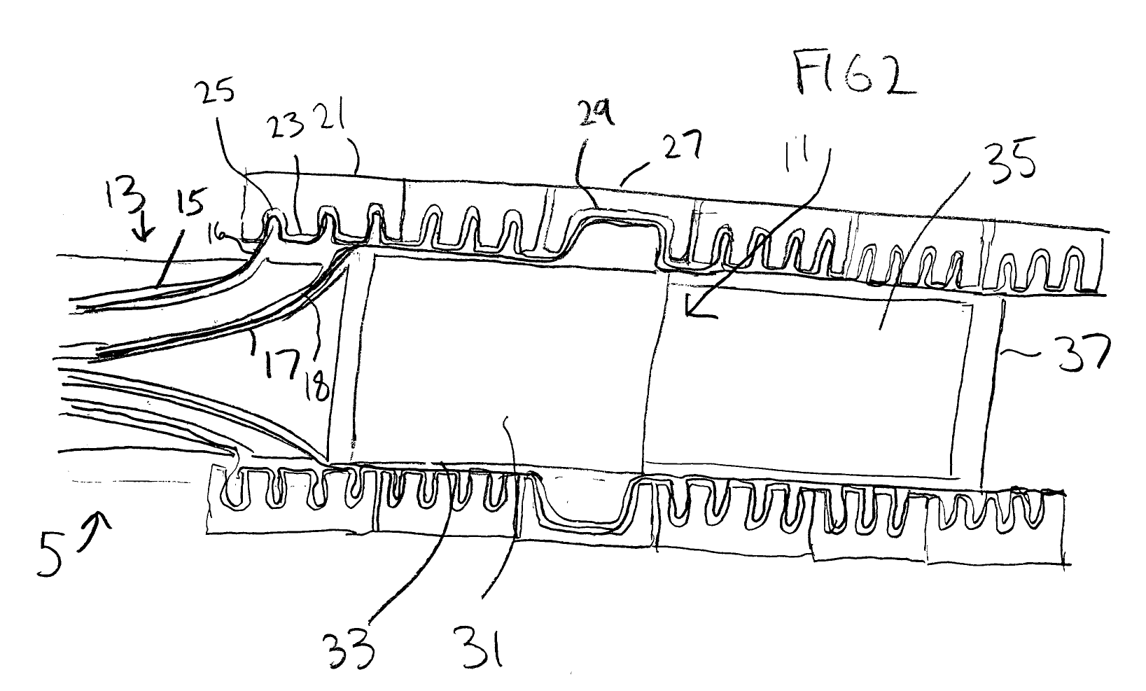

FIG. 2 of the drawings shows that the downstream end 13 of die 5 includes first and second plastic delivery channels 15 and 17 respectively. A flow of plastic 16 emerges from channel 15 to form the profiled outer wall of the pipe. This profile is shaped by troughs 25 separated by crests 23 on the inner face of mold blocks 21. These mold blocks lie side by side with one another within the endless belts of the corrugator 7.

Also provided in the corrugators 7 are mold blocks 27 having recessed mold faces 29. These recessed mold faces 29 of the mold blocks 27 are used to form coupling portions of the profiled pipe.

A flow of plastic 18 from the passage 17 is used to form the inner wall of the pipe. This inner pipe wall adheres to the flats between the corrugations of the outer pipe wall.

The description above relates specifically to a double wall pipe having corrugations on the exterior surface of the pipe. It is to be understood that the present invention which is to be described in greater detail below also pertains to the formation of ribbed pipe made from a single flow of plastic used to provide both the ribs to the exterior surface of the pipe and the inner wall of the pipe.

FIG. 2 also shows very generally the interior pipe cooling system generally indicated at 11. This cooling system comprises a first plastic cooler 31 and a second plastic cooler 35 downstream of cooler 31.

Plastic cooler 31 referred to as a cooling plug has a cooled exterior surface 33 which is spaced from the interior faces of the mold blocks by a distance which is only sufficient to allow the flow of plastic material such that the plastic rides along the exterior surface of the cooling plug and is forced against the interior faces of the mold blocks. Therefore cooling plug 31 acts as both a cooling device and an interior shaping die which is in direct contact with the interior surface of the majority of the length of the pipe. The only exception is at the coupling regions of the pipe where the faces 29 of mold blocks 27 are spaced outwardly from the exterior surface of the cooling plug.

As will be clearly seen in FIG. 2 of the drawings the second plastic cooler 35 is of reduced diameter relative to cooling plug 31 such that the plastic material on the interior faces of the mold blocks is spaced from and out of contact with the exterior surface of cooler 35.

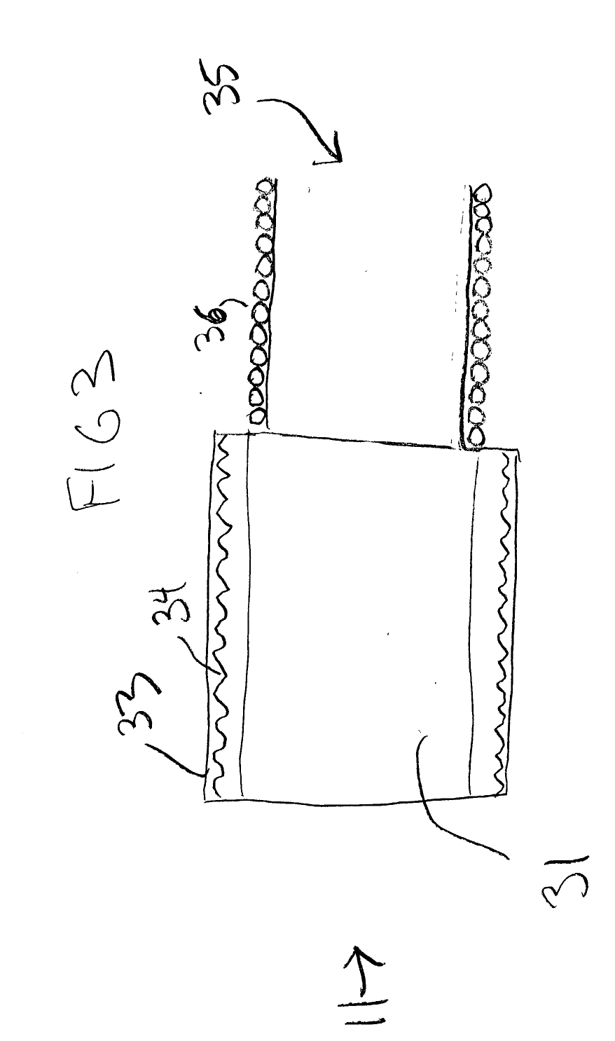

FIG. 3 shows further details of the cooling system 11 of FIGS. 1 and 2. Here it will be seen that cooling plug 31 although having a flat external surface 33 to shape the flat inner wall of the pipe includes fluid flow channels 34 directly below surface 33. These fluid flow channels carry a cooling medium which could either be a chilled liquid or a chilled gas directly below the external cooling surface 33 of the cooling plug. The cooling provided by the medium in channels 34 is transferred through the flat wall 33 of the cooling plug to the interior surface of the pipe by contact between the pipe inner wall and the exterior surface of the cooling plug.

The second plastic cooler 35 as noted above does not make contact with the plastic material in the mold tunnel. Therefore rather than being a contact cooler it provides an air cooling of the plastic material in the mold tunnel.

FIG. 3 shows that according to one embodiment of the invention the exterior surface 36 of cooler 35 is formed by a continuous hollow coil which runs around the exterior surface of the cooler. This coil contains a fluid medium which can either be a liquid or gas which is chilled exteriorly of the mold pipe and then forced to circulate through the coil 36 on the surface of the cooler. Note that coil 36 does not have to be covered by a flat plastic shaping wall since it is not in contact with and does not provide a shaping surface for the inner wall of the pipe. Therefore the cooling effect provided by the medium in the outer surface of cooler 35 is able to radiate without having to go through any type of a barrier onto the inner surface of the plastic material in the mold tunnel which surrounds cooler 35.

The provision of cooler 35 downstream of the cooling plug provides a number of benefits. Firstly, there is an extended length interior cooling of the pipe. In the past, interior pipe coolers without a secondary cooler of the present invention have not been able to sufficiently cool the inner wall of the pipe so as to prevent it from continuously heating the exterior wall of the pipe as the pipe is moving downstream through the mold tunnel. The secondary air cooler of the present invention downstream of the first contact cooler helps to overcome this problem so that it is much easier to provide effective cooling for both the interior and the exterior surface of the pipe.

In addition, prior cooling systems which have made contact with the inner wall of the pipe have not been able to effectively cool the belled out coupling regions of the pipe. This is because these contact cooling systems do not reach into the recessed faces of the mold blocks for forming the coupling regions. Furthermore they are not designed to radiate cooling to the couplings or other similarly belled parts of the pipe. The secondary cooler of the present invention which uses an outward radiation of cooling rather than a contact cooling is able to move cooling air into the belled regions of the pipe.

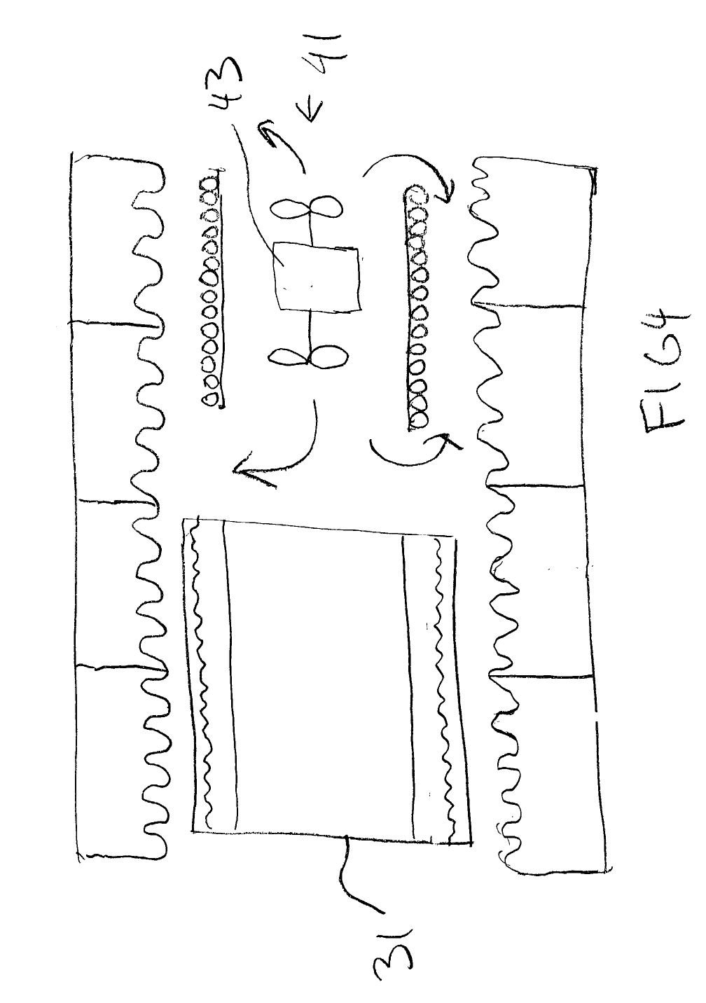

FIG. 4 shows a further embodiment of the invention which again uses cooling plug 31 but which uses a modified second plastic cooler 41 downstream of the cooling plug. This second plastic cooler unlike the cooler 35 in FIG. 3 is separated from and located at a spaced distance downstream from the cooling plug. Provided internally of the hollow construction of cooler 41 is a blower 43.

Cooler 41 not only uses radiant cooling to move cooling air from its exterior surface to the plastic material surrounding the cooler but additionally uses pressurized air for cooling of the plastic material. The positive air pressure provided by blower 43 provides a circulation of the cooling air. This circulation is able to flow around both the upstream and the downstream end of cooler 41 because the downstream end of the cooler is open and the upstream end of the cooler is separated from the cooling plug.

One of the features resulting in the use of a pressurized cooler such as cooler 41 is that any relatively cooled air otherwise trapped within the mold tunnel and normally having a tendency to settle in the lower half of the horizontally extending mold tunnel is circulated by the blower of the second cooler mold. Usually the hotter air will tend to rise to the upper side of the mold tunnel. This results in an uneven cooling of the pipe in the mold tunnel which produces a bending of the pipe as it emerges from the mold tunnel. However, through the provision of blower 43 the relatively cool air which normally drops down into the lower part of the mold tunnel is circulated by the blower producing a more even distribution of the cooling air around the entire inner circumference of the pipe. This in turn produces a straighter pipe emerging from the mold tunnel.

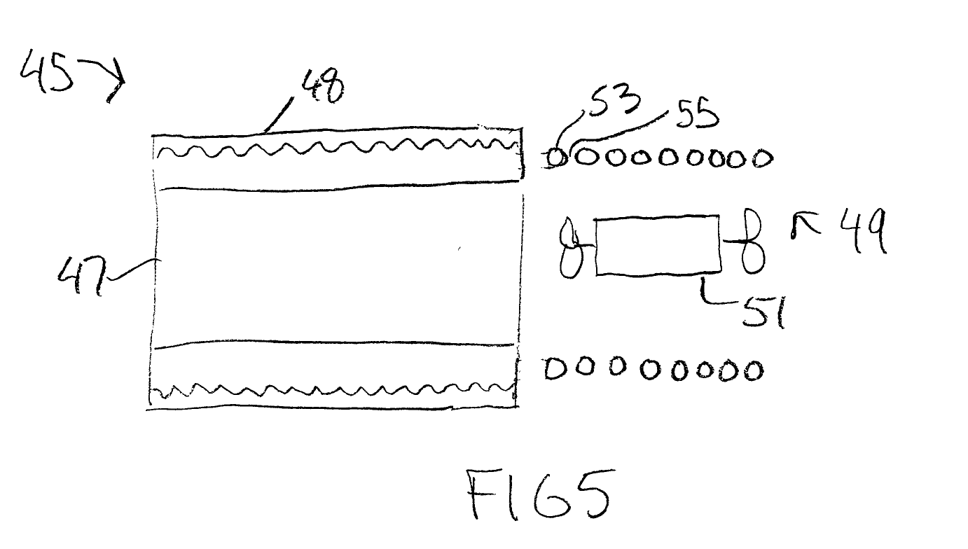

FIG. 5 shows another preferred embodiment cooling system generally indicated at 45 for cooling the interior of a plastic pipe with profiled exterior surface. Cooling system 45 which again locates interiorly of the mold tunnel of the pipe forming apparatus comprises an upstream cooling plug 47 having an exterior surface 48 which is in direct contact with the interior surface of the plastic material and further includes a second downstream plastic material cooler 49. Consistent with the earlier embodiments cooler 49 is of reduced diameter to cooler 47.

In the embodiment shown in FIG. 5 cooler 49 is formed by a cooling medium circulation coil 53 with gaps 55 between the helical turns of the coil. Provided internally of the coil is a blower 51.

In this particular embodiment the blower 51 not only circulates the cooling air to the opposite ends of cooler 49 but additionally produces a positive air pressure directly through the open construction of the main body of the cooler. Therefore, all parts of the cooler are effectively exposed to the plastic material with the air pressure created internally of the cooler sweeping from the inside of the coils through the gaps 55 in the cooler and then outwardly around the coils onto the plastic material surrounding the cooler.

Although FIG. 5 shows a coil style cooler it is to be understood that any other type of open construction cooler will provide the same benefits. For example, a squirrel cage fan housing is presently being used in furnace humidifiers and the like. This same construction modified according to the present invention to additionally include cooling medium channels in the cage construction of the housing could be used in lieu of the coil type construction of the second plastic cooler shown in FIG. 5 of the drawings.

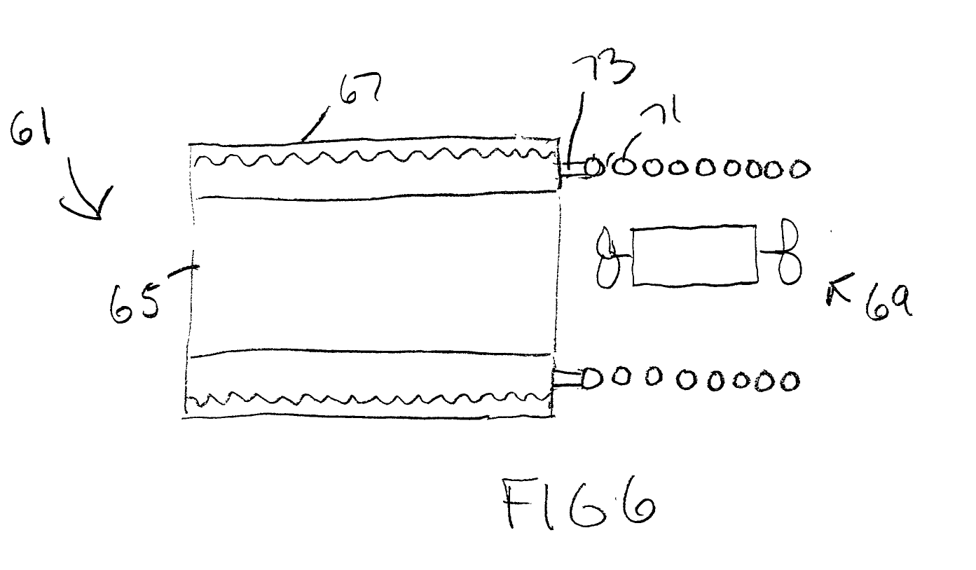

FIG. 6 of the drawings shows yet another preferred embodiment feature of the present invention. This feature is provided in a cooling system generally indicated at 61. Cooling system 61 includes an upstream contact cooler 65 and a downstream air cooler 69. The downstream cooler comprises a cooling medium circulation wall 71 and the upstream cooler has a cooling medium circulation wall 67. In this particular embodiment the cooling wall 71 of the downstream cooler is connected by a fluid passage 73 to the cooling wall 67 of the upstream cooler. This allows both of the coolers to use a common cooling medium which flows between the two coolers. Once again this cooling medium could be a chilled gas or could be a chilled liquid. The upstream cooler provides the benefits of shaping and cooling the portions of the pipe wall in contact with it while the downstream cooler provides the benefit of air cooling to the entire inner wall of the pipe including the belled portions of the pipe wall which will not contact the external surface of the upstream cooler.

A further preferred feature of the present invention is shown in FIG. 2 of the drawings. Here it will be seen that the cooling system further includes a plate 37 downstream of the air cooler. This plate is only slightly smaller in diameter than the inside wall of the pipe. It therefore blocks the cooled air from the second plastic cooler from escaping through the open downstream end of the mold tunnel. Accordingly the cooled air is maintained within the tunnel where it continues to cool the inner wall of the pipe.

Although various preferred embodiments of the present invention have been described in detail, it will be appreciated by those skilled in the art that variations may be made without departing from the spirit of the invention or the scope of the appended claims.

The embodiments of the invention in which an exclusive property or privilege is claimed are defined as follows:

1. Molding apparatus for molding plastic pipe with a profiled outer pipe wall, said molding apparatus including a mold tunnel in which plastic material is shaped to form the pipe, said mold tunnel including a first plastic cooler against which the plastic material flows for contact cooling of the plastic material and further including a second plastic cooler downstream of said first plastic cooler, said second plastic cooler providing an air cooling of plastic material which surrounds said second plastic cooler in the mold tunnel.

2. Molding apparatus for molding plastic pipe with a profiled outer pipe wall, said molding apparatus including a mold tunnel in which plastic material is shaped to form the pipe, said mold tunnel including a first plastic cooler against which the plastic material flows for contacting cooling of the plastic material and further including a second plastic cooler downstream of the first plastic cooler in the mold tunnel, the second plastic cooler being of lesser diameter than the first plastic cooler and being out of contact with the plastic material, the second plastic cooler providing an air cooling of the plastic material which surrounds the second plastic cooler in the mold tunnel.

3. Molding apparatus as claimed in claim 2 wherein said second plastic cooler comprises a hollow body with a hollow wall and a cooling medium contained within the hollow wall of the hollow body.

4. Molding apparatus as claimed in claim 3 wherein said cooling medium comprises a chilled liquid.

5. Molding apparatus as claimed in claim 3 wherein said cooling medium comprises a chilled gas.

6. Molding apparatus as claimed in claim 2 wherein said second plastic cooler is a radiant cooler.

7. Molding apparatus as claimed in claim 3 wherein said hollow wall of said second plastic cooler has an open caged construction and said second plastic cooler includes a blower internally of said hollow wall for blowing outwardly through the open caged construction of said hollow wall to move air cooled by the second plastic cooler onto the plastic material in the mold tunnel.

8. Molding apparatus as claimed in claim 2 wherein said second plastic cooler is spaced downstream of said first plastic cooler.

9. Molding apparatus as claimed in claim 2 wherein said second plastic cooler is located side by side against said first plastic cooler.

10. Molding apparatus as claimed in claim 3 including a fluid passage between said first plastic cooler and said second plastic cooler, the cooling medium flowing through said fluid passage between said first and second plastic coolers.

11. Molding apparatus as claimed in claim 2 wherein said cooling air cooled by the second plastic cooler moves outwardly from the second plastic cooler onto the plastic material surrounding the second plastic cooler in the mold tunnel, the molding apparatus further including an air flow block downstream of the second plastic cooler, the mold tunnel having an open downstream end, the air flow block being located internally of the pipe away from the plastic material and blocking the cooling air produced by the secondary cooler from escaping through the downstream end of the tunnel.
